(19) United States
(12) Patent Application Publication
(10) Pub. No.: US 2010/0027617 A1
(43) Pub. Date: Feb. 4, 2010

(54) METHOD AND APPARATUS FOR COMPRESSING A REFERENCE FRAME IN ENCODING/DECODING MOVING IMAGES

(75) Inventors: Chang-Hyun LEE, Suwon-si (KR); Kwan-Woong SONG, Seongnam-si (KR); Young-Hun JOO, Yongin-si (KR); Yong-Serk KIM, Seoul (KR); Dong-Gyu SIM, Seoul (KR); Sea-Nae PARK, Seoul (KR)

Correspondence Address: SUGHRUE MION, PLLC, 2100 PENNSYLVANIA AVENUE, N.W., SUITE 800, WASHINGTON, DC, 20037, US

(73) Assignees: Samsung Electronics Co., Ltd., Suwon-si (KR); Kwangwoon University Industry-Academic Collaboration Foundation, Seoul (KR)

(21) Appl. No.: 12/511,497

(22) Filed: Jul. 29, 2009

(30) Foreign Application Priority Data
Jul. 29, 2008 (KR) 10-2008-0074290

(51) Int. Cl. H04N 11/04

(52) U.S. Cl. 375/240.01; 375/E07.026

(57) ABSTRACT

Provided is a method of compressing a reference frame in encoding or decoding moving images. A reference frame to be compressed is divided into basic processing blocks. The basic processing blocks are divided into sub-blocks. A maximum value and a minimum value of pixels within each sub-block are calculated. A necessary bit length needed for compression of each sub-block is obtained based on a difference between the maximum value and the minimum value. An average bit length of the sub-blocks within the basic processing block is calculated based on the calculated necessary bit lengths of the sub-blocks. Bits are variably allocated to each sub-block by adjusting the necessary bit length of each sub-block so that the average bit length of the sub-blocks within a corresponding basic processing block is less than or equal to a preset required bit length. Each sub-block is compressed to the allocated bits.

### CROSS-REFERENCE TO RELATED APPLICATION

This application claims priority from the Korean Patent Application No. 10-2008-0074290 filed in the Korean Industrial Property Office on Jul. 29, 2008 and assigned Serial No. 10-2008-0074290, the content of which is hereby incorporated by reference in its entirety.

### BACKGROUND OF THE INVENTION

1. Field of the Invention

Apparatuses and methods consistent with the present invention relate to encoding/decoding of moving images, and more particularly, to compressing and restoring a reference image.

2. Description of the Related Art

In general, when encoding/decoding of moving images is performed, images of a previous frame are stored for reference to improve the efficiency of compression and restoration of the images. The previously encoded or decoded images may be stored in a frame buffer and the current image frame may be encoded or decoded by referencing the stored images. To improve the efficiency of memory utilization, a reference frame which is to be stored in the frame buffer may be compressed. However, compression of a reference frame might cause a loss of the reference frame and result in a poor image quality of the final images.

Accordingly, reference frame compression method may lead to deterioration of a reference frame. Also, when an encoding or decoding operation references the reference frame deteriorated by the compression, the efficiency of the image encoding or decoding decreases. Therefore, a method of minimizing the image deterioration due to the compression of the reference frames as well as improving the compression efficiency of the reference frame is required.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

According to an aspect of one or more exemplary embodiments of the present invention, there is provided a method and an apparatus of compressing a reference frame in encoding/decoding moving images for minimizing the deterioration of images due to the compression of the reference frame as well as decreasing the memory utilization and the power dissipation by compressing the image referenced when encoding/decoding moving images.

In accordance with an exemplary aspect of the present invention, there is provided a method of compressing a reference frame in encoding/decoding moving images including the step of dividing a reference frame to be compressed into preset basic processing block units, the step of calculating and storing a maximum value and a minimum value of the pixels within each preset sub-block by dividing the basic processing block into sub-blocks, the step of obtaining a necessary bit needed for compression of each sub-block according to a difference between the maximum value and the minimum value and calculating an average necessary bit of each sub-block within the basic processing block, the step of changeably allocating said each sub-block bits by adjusting the necessary bit of said each sub-block so that the necessary bit of said each sub-block within the basic processing block is smaller than a preset, allocated required bit, and the step of compressing each sub-block to an allocated bit size.

In accordance with another exemplary aspect of the present invention, there is provided an apparatus of compressing a reference frame in encoding/decoding moving images including a maximum/minimum value calculating unit for dividing a reference frame to be compressed into a preset basic processing block unit, dividing the basic processing block into preset sub-blocks and calculating a maximum value and a minimum value of the pixels within said each sub-block, a maximum/minimum value storing unit for storing the maximum and minimum values of said each sub-block, a sub-block bit calculating unit for obtaining a necessary bit needed for compression of each sub-block according to a difference between the maximum value and the minimum value calculated at the maximum/minimum value calculating unit and calculating an average necessary bit of each sub-block within the basic processing block, a bit allocating unit for changeably allocating said each sub-block bits by adjusting the necessary bit of said each sub-block so that the necessary bit of said each sub-block within the basic processing block is smaller than a preset, allocated required bit and compressing images to allocated bits, and a reference frame storing unit for storing the reference frame compressed through the sub-block bit calculating unit and the bit allocating unit.

### BRIEF DESCRIPTION OF THE DRAWINGS

The above and other aspects of the present invention will become apparent and more readily appreciated from the following description of exemplary embodiments with reference to the accompanying drawings, in which:

FIG. 1 is a block diagram of a moving images encoding apparatus according to an exemplary embodiment of the present invention;

FIG. 2 is a block diagram of a moving images decoding apparatus according to an exemplary embodiment of the present invention;

FIG. 3 shows a basic processing block for compressing a reference frame according to an exemplary embodiment of the present invention;

FIG. 4 is a block diagram representing the operation of extracting a reference frame stored in a memory according to an exemplary embodiment of the present invention;

FIG. 5 is a flowchart of the operation of compressing a reference frame according to an exemplary embodiment of the present invention;

FIG. 6 is a flowchart of the operation of restoring a reference frame according to an exemplary embodiment of the present invention; and

FIG. 7 illustrates a flowchart for compressing a reference frame according to an exemplary embodiment of the present invention.

### DETAILED DESCRIPTION OF EXEMPLARY EMBODIMENTS

Exemplary embodiments of the present invention are described in detail below with reference to the accompanying drawings.

The present invention relates to encoding/decoding of moving images, and especially to a method and an apparatus of compressing and restoring an image referenced in encoding/decoding images. Accordingly, an exemplary embodiment of the present invention uses a variable bit allocating approach in each sub-block to obtain a higher compressibility without greatly raising the complexity of apparatuses thereby to minimize the degradation of a picture quality through a reference frame compression and a maximum and minimum quantization approach of a block-unit image. Thus, the present invention may embody an image encoding and decoding system which improves the efficiency of a memory use and power dissipation by minimizing the degradation of a picture quality and realizing a higher compressibility.

The present invention relates to a technology for compressing, storing and restoring, for reference, a reference frame to efficiently manage a restoring image storing unit in encoding and decoding moving images, and particularly it may decrease the deterioration of a picture quality due to a reference frame compression and keep accessibility to a reference frame storing space by using a characteristic of a reference frame to be compressed and also by variably allocating each pixel a bit length, in a different way from a prior art reference frame compression method.

In the following description, like drawing reference numerals are used for like elements, even in different drawings. The matters defined in the description, such as detailed construction and elements, are provided to assist in a comprehensive understanding of the invention. However, the present invention can be practiced without those specifically defined matters. Also, well-known functions or constructions are not described in detail since they would obscure the invention with unnecessary detail.

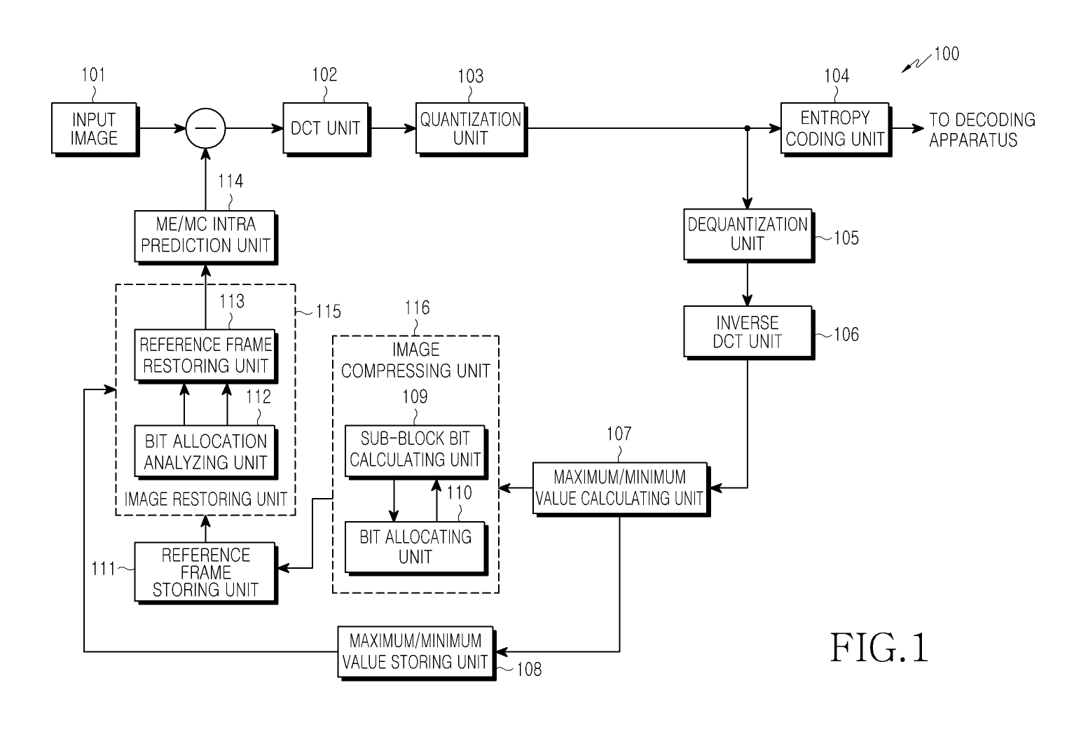

FIG. 1 is a block diagram of a moving images encoding apparatus 100 according to an exemplary embodiment of the present invention. Referring to FIG. 1, a moving images encoding apparatus 100 includes Discrete Cosine Transform (DCT) unit 102, a quantization unit 103, an entropy coding unit 104, a dequantization unit 105, an inverse DCT unit 106, a maximum/minimum value calculating unit 107, a maximum/minimum value storing unit 108, an image compressing unit 116, a reference frame storing unit 111, an image restoring unit 115, and a motion estimation (ME)/motion compensation (MC) intra prediction unit 114.

The image compressing unit 116 includes a sub-block bit calculating unit 109 and a bit allocating unit 110. The image restoring unit 115 includes a bit allocation analyzing unit 112 and a reference frame restoring unit 113.

The DCT unit 102 performs a discrete cosine transform to transform picture element values of images into DCT coefficients.

The quantization unit 103 quantizes the DCT coefficients generated by the DCT unit 102.

The entropy coding unit 104 entropy-codes the quantized result and outputs the entropy coded result as a bit stream.

The dequantization unit 105 dequantizes the quantized result of the quantization unit 103. The inverse DCT unit 106 performs an inverse discrete cosine transform of the dequantized result of the dequantization unit 105. The dequantization unit 105 and the inverse DCT unit 106 generate a reference frame used in encoding of the next image.

The maximum/minimum value calculating unit 107 divides a reference frame to be compressed into basic processing blocks of a predetermined size, for example, an 8×8 pixel size, and further divides each basic processing block into sub-blocks of a predetermined size, for example, a 4×4 pixel size. The maximum/minimum value calculating unit 107 calculates a maximum value and a minimum value of each sub-block of 4×4 pixel size of the basic processing block. The maximum value and a minimum value of the sub-block are calculated by the maximum value and the minumum value among 16 pixel values within the sub-bclock, respectively. The calculated maximum and minimum values of pixels of each sub-block are stored in the maximum/minimum value storing unit 108. In an exemplary embodiment of the present invention, the size of the basic processing block is set to an 8×8 pixel size, and the size of the sub-block is set to a 4×4 pixel size. The size of the basic processing block and the sub-block may be differently defined according to characteristics of an apparatus.

The image compressing unit 116 analyzes the characteristics of the sub-block, variably allocates bits to the sub-block and compresses the pixels of a reference frame into the allocated bits. Specifically, the sub-block bit calculating unit 109 included in the image compressing unit 116 calculates a necessary bit length, that is, how many bits are to be allocated in the sub-block for lossless compression, based on a maximum value and a minimum value calculated by the maximum/minimum value calculating unit 107. The necessary bit length is calculated by taking log2 of the difference between the maximum value and the minimum value. The necessary bit length is obtained by processing each sub-block within the 8×8 basic processing block. An average of the calculated necessary bit lengths of the sub-blocks of each basic processing block is calculated.

The bit allocating unit 110 variably allocates bits to each sub-block within the basic processing block based on the analysis of the sub-block bit calculating unit 109. For example, if an average of bit lengths allocated to each pixel within a basic processing block is M bits (a required bit), an overall number of bits to be allocated to the basic processing block cannot exceed a product of a size of the basic processing block and a value of M.

For example, if a preset required pixel bit length allocated to a pixel for compression is 4 bits and the size of the basic processing block is 8×8 pixels, then the overall number of bits cannot exceed 256 bits. The necessary bit length calculated for each sub-block is allocated to a corresponding sub-block for performing a compression if the calculated average bit length is smaller than or equal to the required pixel bit length of 4 bits. However, if the calculated average bit length is greater than the required pixel bit length, the necessary bit lengths are adjusted by decreasing the bit lengths by one bit, in steps, in the sub-blocks in a predetermined order, as described in detail below. The average bit length is recalculated with the current necessary bit lengths. The process continues until the recalculated average bit length is smaller than or equal to the required pixel bit length of 4 bits.

For example, if the initial necessary bit lengths of four sub-blocks are 3 bits, 4 bits, 4 bits, and 5 bits, respectively, the average of the necessary bit lengths of the sub-blocks is 4 bits, which corresponds to the required pixel bit length. Therefore, the sub-blocks are compressed after being allocated 3 bits, 4 bits, 4 bits, and 5 bits, respectively, without change in the initially calculated necessary bit lengths.

If the initial necessary bit lengths of four sub-blocks are 4 bits, 5 bits, 5 bits, and 5 bits, respectively, the average of the necessary bit lengths of the sub-blocks exceeds 4 bits, which is the required bit length. In this case, the necessary initial bit length of the sub-blocks is decreased sequentially by one bit in each sub-block until the average of the necessary bit lengths of the sub-blocks satisfies the required pixel bit length. In the current example with the sub-blocks having 4, 5, 5, and 5 initial necessary bit lengths, one bit is subtracted from the necessary bit length of a first block. The necessary bit lengths become 3, 5, 5, and 5 bits. An average value is recalculated to determine if the average value satisfies the required pixel bit length. If the recalculated average satisfies a required pixel bit length, each sub-block is allocated the current bit length, or otherwise, one bit is subtracted from the necessary bit length of a second sub-block. Accordingly, the necessary bit lengths become 3, 4, 5, and 5 bits, and the recalculated average value does not satisfy the required pixel bit length. Therefore, one bit is subtracted from the necessary bit length of a third sub-block. The necessary bit lengths become 3, 4, 4, and 5 bits, and the recalculated average value satisfies the required pixel bit length. Therefore, the sub-blocks are allocated 3 bits, 4 bits, 4 bits, and 5 bits, respectively, as determined by the current step.

The reference frame storing unit 111 stores a reference frame compressed by the image compressing unit 116 based on the allocated bits.

The image restoring unit 115 analyzes the compressed, stored reference frame using the stored maximum value and minimum value to restore a reference frame. Specifically, the bit allocation analyzing unit 112 included in the image restoring unit 115 calculates variably allocated bit lengths of each sub-block by retrieving the maximum value and the minimum value stored in the maximum/minimum value storing unit 108 to restore the reference frame stored in the reference frame storing unit 111. The reference frame restoring unit 113 restores a reference frame using the bit lengths calculated and allocated to each sub-block by the bit allocation analyzing unit 112.

The ME/MC intra prediction unit 114 performs motion estimation/motion compensation and intra estimation of the restored reference frame.

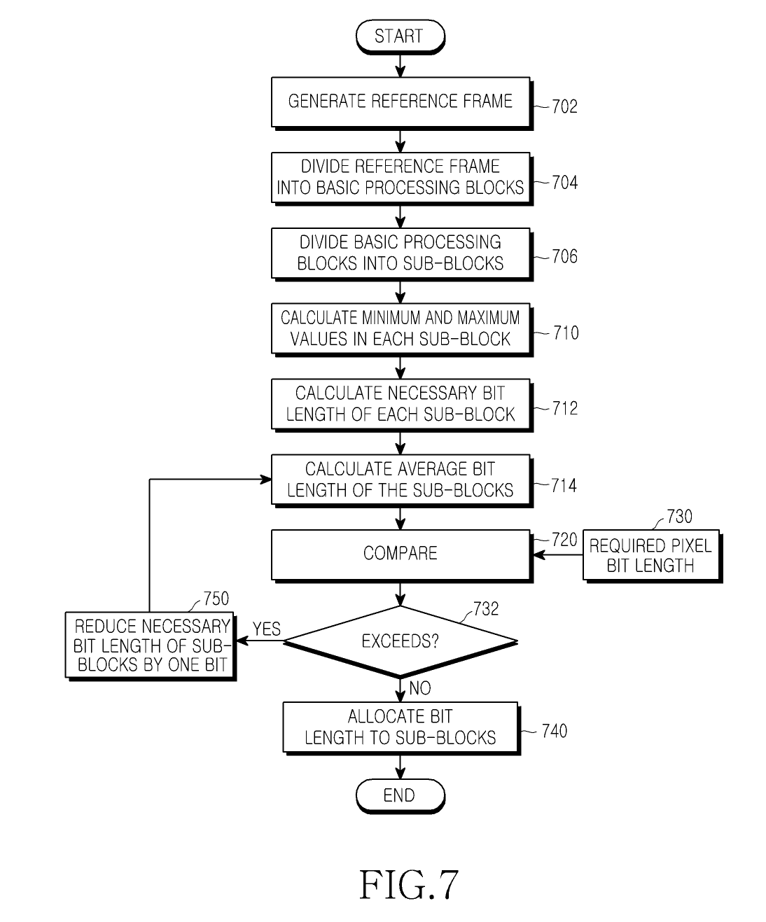

Next, referring to FIG. 7, the operation of compressing a reference frame in encoding moving images according to an exemplary embodiment of the present invention is described. First, images 101 inputted for encoding moving images are encoded through a DCT unit 102, a quantization unit 103, and an entropy coding unit 104 according to general image encoding methods. According to an exemplary embodiment of the present invention, a reference frame to be used when encoding the subsequently encoded images is generated in operation 702. In operation 704, the reference frame to be compressed is divided into basic processing blocks of a predefined pixel size. In operation 706, each basic processing unit is divided into sub-blocks of a predefined pixel size. In operation 710, the maximum value and the minimum value of each sub-block of the basic processing blocks are calculated.

In operation 712, the necessary initial bit lengths of the sub-blocks are calculated. In operation 714, the average bit length of the calculated necessary bit lengths is determined. In operation 720, the average bit length is compared to the required pixel bit length 730. In operation 732, it is determined whether the average bit length exceeds the required pixel bit length. If the answer is negative, the necessary bit lengths are allocated to corresponding sub-blocks, in operation 740. If the average bit length is greater than the required pixel bit length, the necessary bit lengths of the sub-blocks are reduced in steps, by one bit from each sub-block, in the predetermined order, in operation 750. The process returns to operation 714 and the average bit length is re-calculated with the currently determined necessary bit lengths. The process continues until the re-calculated average bit length is less than or equal to the required pixel bit length. The necessary current bit lengths are then allocated to corresponding sub-blocks, in operation 740.

In this manner, the bit lengths are allocated variably to each sub-block according to the calculation of the sub-block bit calculating unit 109. The compression of the reference frame is performed based on the variably allocated bit lengths. Herein, if a required bit length in the basic processing block that is allocated for compression is M bits, then the sum of bits to be allocated in the basic processing block cannot exceed a product of the size of a basic processing block and a value of M.

A reference frame compressed by the image compressing unit 116 is stored in the reference frame storing unit 111.

With reference again to FIG. 1, in restoring the reference frame, the bit allocation analyzing unit 112 calculates variable bit lengths allocated to each sub-block. The bit lengths are calculated using the maximum and minimum values stored in the maximum/minimum value storing unit 108 to restore a reference frame stored in the reference frame storing unit 111. The reference frame restoring unit 113 restores a reference frame based on the bit lengths allocated to each sub-block by the bit allocation analyzing unit 112.

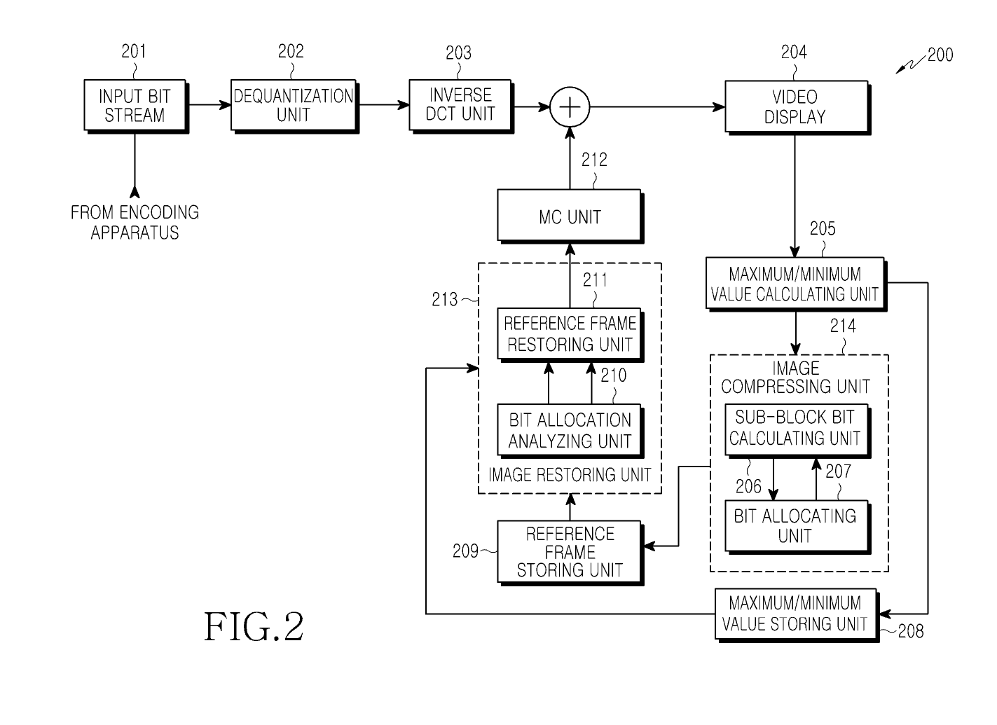

FIG. 2 is a block diagram of a moving images decoding apparatus 200 according to an exemplary embodiment of the present invention. Referring to FIG. 2, a moving images decoding apparatus 200 according to an exemplary embodiment of the present invention includes a dequantization unit 202, an inverse DCT unit 203, a video display 204, a maximum/minimum value calculating unit 205, an image compressing unit 214, a maximum/minimum value storing unit 208, a reference frame storing unit 209, an image restoring unit 213, and an MC unit 212. The image compressing unit 214 includes a sub-block bit calculating unit 206 and a bit allocating unit 207. The image restoring unit 213 includes a bit allocation analyzing unit 210 and a reference frame restoring unit 211.

The dequantization unit 202 receives an input bit stream 201 and performs dequantization.

The inverse DCT unit 203 performs an inverse discrete cosine transform of the dequantized information provided by the dequantization unit 202.

The video display 204 restores the original image and displays the restored image by referencing a previously decoded image.

The maximum/minimum value calculating unit 205 divides the restored image into basic processing blocks of a predetermined size, for example, an 8×8 pixel size to store the restored image as a reference frame. The processing blocks are further divided into sub-blocks of a predetermined size, for example, a 4×4 pixel size. The maximum/minimum value calculating unit 205 calculates a maximum value and a minimum value of pixels of each sub-block of 4×4 pixel size within the basic processing block. The calculated maximum value and minimum value of each sub-block are stored in the maximum/minimum value storing unit 208.

The image compressing unit 214 compresses pixels of the reference frame into allocated bits by analyzing characteristics of a sub-block and the corresponding basic processing block. Specifically, the sub-block bit calculating unit 206 calculates a necessary bit length regarding how many bits are to be allocated to a sub-block for lossless compression, based on the maximum value and minimum value calculated in the maximum/minimum value calculating unit 205. The necessary bit length is calculated by taking log2 of a difference between the maximum value and the minimum value for each 4×4 sub-block of the 8×8 basic processing blocks. The average of the calculated necessary bit lengths of the sub-blocks is calculated.

The bit allocating unit 207 allocates bits of variable length to each sub-block within the basic processing block according to the analysis of the sub-block bit calculating unit 206. If a pixel bit length set to a pixel within a basic processing block is M bits, an overall number of bits to be allocated in the basic processing block cannot exceed a product of the size of a basic processing block and a value of M. For example, the required pixel bit length predefined for compression is 4 bits. If the average of the necessary bit lengths satisfies the overall number of bits, a compression is performed by allocating the calculated necessary bit lengths to the corresponding sub-blocks. If the calculated average of necessary bit lengths exceeds the required pixel bit length, the necessary bit lengths are adjusted to the required pixel bit length by decreasing the number of bits by one in each sub-block in a predetermined order, as explained above with reference to FIGS. 1 and 7.

The reference frame storing unit 209 stores a reference frame compressed by the image compressing unit 214 based on the allocated bits.

The image restoring unit 213 analyzes the reference frame compressed and stored using the stored maximum value and minimum value to restore a reference frame. Specifically, the bit allocation analyzing unit 210 calculates variably allocated bits of each sub-block based on the maximum and minimum values retrieved from the maximum/minimum value storing unit 208 to restore the reference frame stored in the reference frame storing unit 209. The reference frame restoring unit 211 restores a reference frame using the bits allocated to each sub-block by the bit allocation analyzing unit 210.

The MC unit 212 performs a motion compensation of the restored reference frame.

A reference frame compressing method for a decoding operation by a moving images decoding apparatus according to an exemplary embodiment of the present invention is performed in a manner similar to what is described above with reference to the frame compressing method described with reference to FIG. 7.

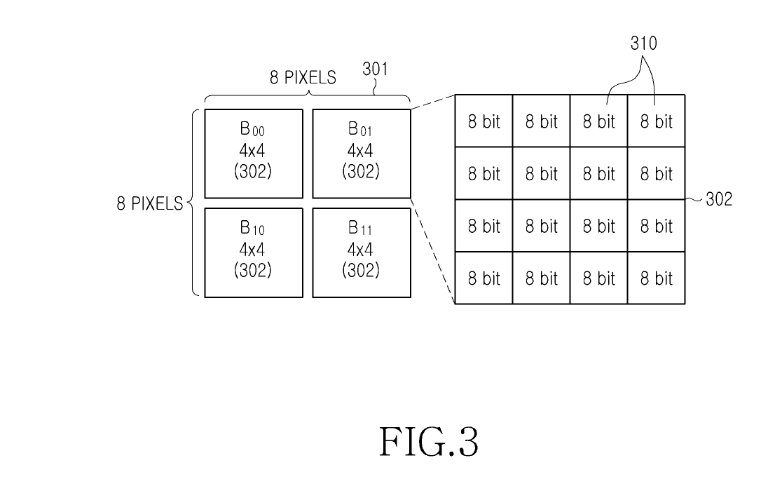

FIG. 3 illustrates a basic processing block for a reference frame compression in encoding/decoding the moving images according to an exemplary embodiment of the present invention. Referring to FIG. 3, a basic processing block 301 of an exemplary embodiment of the present invention is set to an 8×8 pixel size. The basic processing block unit 301 of an 8×8 pixel size is divided into four sub-blocks 302 of a 4×4 pixel size. Each pixel 310 of a reference frame before a compression has a bit length of 8 bits. A maximum value and a minimum value of 16 pixel values within the sub-block 302 are calculated by the maximum/minimum value calculating unit 107, 205. The calculated maximum value and minimum value are stored in the maximum/minimum value storing unit 108, 208. Based on the difference between the maximum value and the minimum value of the sub-blocks 302 of 4×4 pixel size within the basic processing block 301, an allocation of a variable bit length to the sub-blocks 302 is performed. As explained above, the bit lengths are allocated to not exceed the overall number N of the allocated variable bit lengths within the basic processing block 301:

N≦8×8×M bits, where

8×8 is the size of the basic processing block, and
M bits is the required pixel bit length allocated over all of the images.

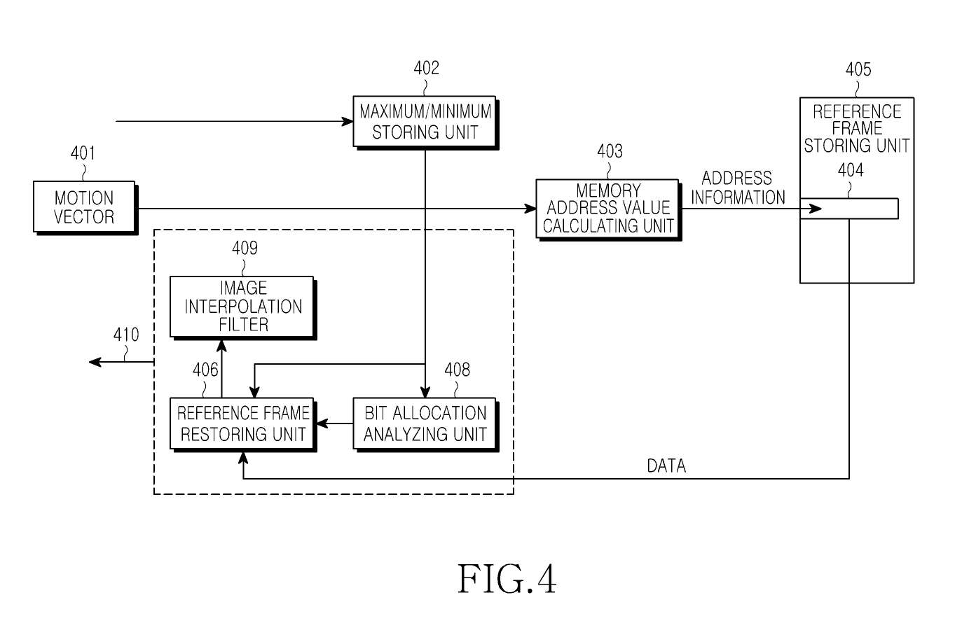

FIG. 4 illustrates the operation of extracting a reference frame stored in a memory in decoding moving images according to an exemplary embodiment of the present invention. Referring to FIG. 4, a memory address value calculating unit 403 determines the repository location of data needed in a compressed reference frame using a motion vector 401 of the currently decoded block. Because image data located at the calculated address 404 of a reference frame storing unit 405 which stores the compressed image is not directly usable information but is a compressed reference frame, it is restored into the original reference frame prior to the compression. A bit allocation analyzing unit 408 determines bit lengths allocated to each sub-block of 4×4 pixel size within a basic processing block having 8×8 pixel size using the maximum value and the minimum value stored in a maximum/minimum value storing unit 402. A reference frame restoring unit 406 executes inverse maximum and minimum quantization based on the difference of the maximum value and the minimum value.

According to an exemplary embodiment of the present invention, since a unit of a data compression processed basic block stored in the reference frame storing unit 405 is an 8×8 pixel size, the image information obtained through the inverse maximum and minimum quantization becomes block information of an 8×8 pixel size. By filtering with an image interpolation filter 409, necessary image information obtained from the 8×8 block information using a motion vector 401, a piece of image reference information for motion restoration is obtained.

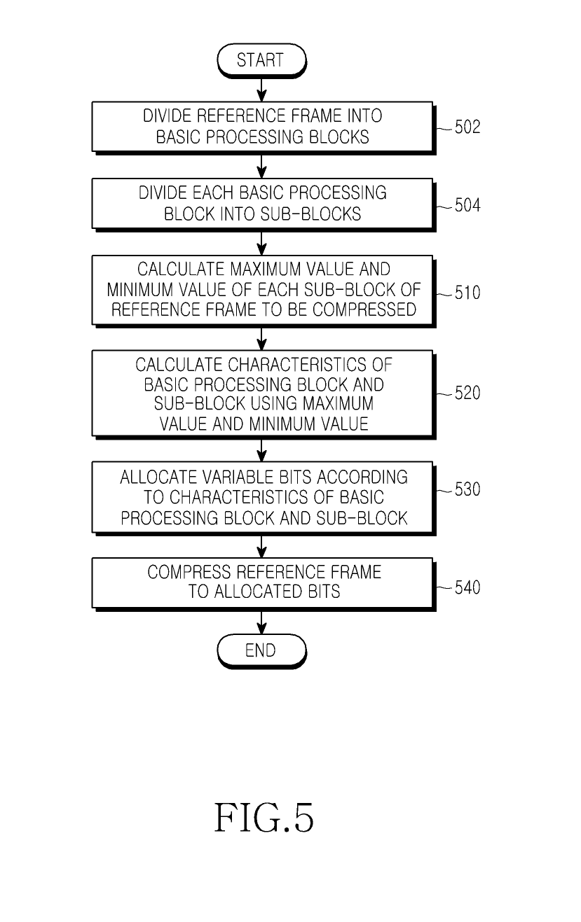

FIG. 5 is a flowchart of the compression operation of a reference frame in encoding/decoding moving images according to an exemplary embodiment of the present invention. In operation 502, a reference frame to be compressed is divided into basic processing blocks having a preset pixel size. In operation 504, the basic processing block is divided into sub-blocks of a predetermined pixel size. A maximum value and a minimum value of pixels within each sub-block are calculated for compressing the reference frame in operation 510. According to an exemplary embodiment of the present invention, the basic processing block is set to an 8×8 pixel size and a sub-block is set to a 4×4 pixel size. In operation 520, based on the calculated maximum value and minimum value of each sub-block, the characteristics of the corresponding basic processing block and sub-block are analyzed. The characteristic may be a difference between a maximum value and a minimum value of each sub-block. The number of bits needed in a compression may be obtained using the difference between the maximum value and the minimum value. An average of the calculated necessary bit lengths of each sub-block of each basic processing block is calculated. In operation 530, bits are variably allocated according to the characteristics of the corresponding basic processing block and sub-block. The bits may be variably allocated by comparing the calculated average of necessary bit lengths of each sub-block with the preset required pixel bit length. Subsequently, in operation 540, the reference frame for each sub-block is compressed to the allocated bits.

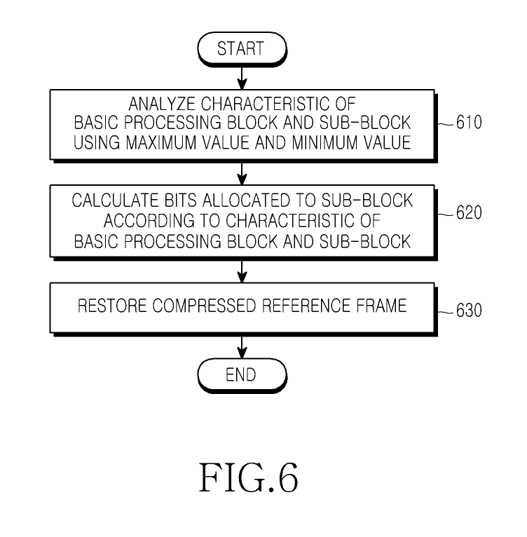

FIG. 6 is a flowchart of the restoration operation of a reference frame in encoding/decoding moving images according to an exemplary embodiment of the present invention. Referring to FIG. 6, characteristics of each sub-block and the corresponding basic processing block are analyzed using a maximum value and a minimum value of each sub-block stored in the maximum/minimum value storing unit 108, 208 to restore a compressed reference frame in operation 610. In operation 620, bit lengths allocated in each sub-block are calculated according to the characteristics of each sub-block and the corresponding basic processing block. In operation 630, the reference frame is restored.

The present invention may obtain a higher compressibility without greatly raising the complexity of apparatuses to minimize the degradation of a picture quality due to a reference frame compression and a block-unit maximum and minimum quantization approach of an image by using a variable bit allocation method when compressing an image referenced in encoding/decoding of moving images so that the memory utilization and the power dissipation may be reduced and the overall enhancement of the encoding and decoding moving images may be enhanced.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A method for compressing a reference frame in encoding or decoding moving images, the method comprising:
dividing a reference frame to be compressed into basic processing blocks;
dividing the basic processing blocks into sub-blocks;
calculating and storing a maximum value and a minimum value of pixels within each sub-block;
obtaining a necessary bit length needed for compression of each sub-block based on a difference between the maximum value and the minimum value;
calculating an average bit length of the sub-blocks within the basic processing block based on the calculated necessary bit lengths of the sub-blocks;
variably allocating bits to each sub-block by adjusting the necessary bit length of each sub-block so that the average bit length of the sub-blocks within a corresponding basic processing block is less than or equal to a preset required bit length to be allocated to a pixel within the corresponding basic processing block; and
compressing each sub-block to the allocated bits.

2. The method of claim 1, further comprising:
detecting the bits allocated to each sub-block within the corresponding basic processing block based on the stored maximum value and minimum value of the pixels within each sub-block; and
restoring the reference frame based on the bits detected for each sub-block.

3. The method of claim 1, wherein a size of the basic processing block is set to an 8×8 pixel size.

4. The method of claim 1, wherein a size of the sub-block is set to a 4×4 pixel size.

5. The method of claim 1, wherein the variably adjusting the necessary bit length of each sub-block comprises:
(a) reducing the necessary bit length of the sub-blocks by one bit in a pre-defined sub-block order;
(b) calculating the average bit length of the sub-blocks subsequent to the reducing the necessary bit length of a corresponding sub-block;
(c) determining whether the calculated average bit length exceeds the required bit length; and
(d) allocating the necessary bit lengths calculated in (a) to the sub-blocks, or repeating (a) through (c).

6. The method of claim 1, wherein the allocating the bits to each sub-block includes:
allocating the bits for the basic processing block to not exceed a size of the basic processing block multiplied by the preset required bit length.

7. An apparatus for compressing a reference frame in encoding or decoding moving images, the apparatus comprising:
a maximum/minimum value calculating unit which divides a reference frame to be compressed into basic processing blocks, divides the basic processing blocks into sub-blocks, and calculates a maximum value and a minimum value of pixels within each sub-block;
a maximum/minimum value storing unit which stores the calculated maximum and minimum values of each sub-block;
a sub-block bit calculating unit which determines a necessary bit length needed for compression of each sub-block based on a difference between the calculated maximum value and the minimum value, and calculates an average necessary bit length of the sub-blocks within a corresponding basic processing block, based on the calculated necessary bit lengths of the sub-blocks;
a bit allocating unit which variably allocates bits to each sub-block by adjusting the necessary bit length of the sub-blocks so that the average bit length of the sub-blocks within the corresponding basic processing block is less than or equal to a required bit length predefined for compression to be allocated to a pixel in the basic processing block, and compresses images to the allocated bits; and
a reference frame storing unit which stores the compressed reference frame.

8. The apparatus of claim 7, further comprising:
a bit allocation analyzing unit which detects the bits allocated to each sub-block based on the stored maximum value and the minimum value of the pixels within each sub-block to restore the reference frame stored in the reference frame storing unit; and
a reference frame restoring unit which restores the reference frame based on the bits detected by the bit allocation analyzing unit.

9. The apparatus of claim 7, wherein a size of the basic processing block is set to an 8×8 pixel size.

10. The apparatus of claim 7, wherein a size of the sub-block is set to a 4×4 pixel size.

11. The apparatus of claim 7, wherein the bit allocating unit variably adjusts the necessary bit length of each sub-block by decreasing the necessary bit lengths in steps, by one bit, from the sub-blocks in a pre-defined sub-block order.

12. The apparatus of claim 7, wherein the bit allocating unit variably allocates the bits to each sub-block by allocating the bits over the basic processing block to not exceed a size of the basic processing block multiplied by the required bit length.
